(19) United States
(12) Patent Application Publication
(10) Pub. No.: US 2026/0246708 A1
(43) Pub. Date: Aug. 20, 2026

(54) COMMUNICATION PATH DETERMINATION DEVICE, COMMUNICATION PATH DETERMINATION METHOD, COMMUNICATION DEVICE, COMMUNICATION CONTROL DEVICE, AND COMMUNICATION SYSTEM

(71) Applicant: NEC Corporation, Tokyo (JP)

(72) Inventor: Yohei HASEGAWA, Tokyo (JP)

(73) Assignee: NEC Corporation, Tokyo (JP)

(21) Appl. No.: 19/164,369

(22) PCT Filed: Mar. 30, 2023
(86) PCT No.: PCT/JP2023/013386

§ 371 Date: Sep. 11, 2025

(51) Int. Cl. H04L 41/147; H04B 10/112; H04Q 11/00

(52) U.S. Cl. CPC H04L 41/147; H04B 10/1129; H04Q 11/0062; H04Q 2011/0073

(57) ABSTRACT

A communication path determination device determines a communication path on a communication network having a plurality of nodes and a plurality of links connecting the plurality of nodes by free-space optical communications, and is provided with an information processing unit, and the information processing unit executes: acquisition processing for acquiring weather information and the communication quality of at least one link among the plurality of links; prediction processing for, on the basis of the weather information and the communication quality of the at least one link, predicting communication qualities of the plurality of links after a predetermined time; and determination processing for, on the basis of the predicted communication qualities, determining a communication path after the predetermined time.

### TECHNICAL FIELD

The present invention relates to a communication path determination device, a communication path determination method, a communication device, a communication control device, and a communication system.

### BACKGROUND ART

Free-space optical communications (FSOC) for performing communication using a light beam has been developed (see PTL 1). The FSOC is expected as a technology capable of improving a communication speed of a wireless communication network.

### CITATION LIST

### Patent Literature

PTL 1: JP 2008-28632 A

### SUMMARY OF INVENTION

### Technical Problem

However, in the FSOC, communication may be interrupted due to a weather event such as heavy rain or strong wind. On the other hand, heavy rain and strong wind are weather events that occur locally and in a short time, and the forecast thereof is not easy.

An aspect of the present invention has been made in view of the above problems, and an object of the present invention is to provide a communication path determination device, a communication path determination method, a communication device, a communication control device, and a communication system capable of determining a future communication path in consideration of an influence of a local weather event.

### Solution to Problem

A communication path determination device according to an aspect of the present invention determines a communication path on a communication network having a plurality of nodes and a plurality of links connecting the plurality of nodes by free-space optical communications, the device including an information processing unit, in which the information processing unit executes acquisition processing for acquiring weather information and communication quality of at least one link among the plurality of links, prediction processing for, based on the weather information and the communication quality of the at least one link, predicting communication qualities of the plurality of links after a predetermined time, and determination processing for, based on the predicted communication qualities, determining a communication path after the predetermined time.

A communication path determination method according to an aspect of the present invention determines a communication path on a communication network having a plurality of nodes and a plurality of links connecting the plurality of nodes by free-space optical communications, the method including acquisition processing for acquiring weather information and communication quality of at least one link among the plurality of links, prediction processing for, based on the weather information and the communication quality of the at least one link, predicting communication qualities of the plurality of links after a predetermined time, and determination processing for, based on the predicted communication qualities, determining a communication path after the predetermined time.

A communication device according to an aspect of the present invention is arranged at one node on a communication network having a plurality of nodes and a plurality of links connecting the plurality of nodes by free-space optical communication, the communication device including, an optical transmission/reception unit that performs free-space optical communication with a communication device arranged at another node on the communication network, and an information processing unit, in which the information processing unit executes acquisition processing for acquiring weather information and communication quality of at least one link among the plurality of links, prediction processing for predicting the communication quality of the plurality of links after a predetermined time based on the weather information and the communication quality of the at least one link, and notification processing for notifying the predicted communication quality.

A communication control device according to an aspect of the present invention includes a second information processing unit that executes determination processing for determining a communication path after the predetermined time based on the predicted communication quality notified from the communication device.

A communication system according to one aspect of the present invention includes a communication device and a communication control device.

### Advantageous Effects of Invention

According to one aspect of the present invention, it is possible to provide a communication path determination device, a communication path determination method, a communication device, a communication control device, and a communication system capable of determining a future communication path in consideration of an influence of a local weather event.

### BRIEF DESCRIPTION OF DRAWINGS

FIG. 1 is a block diagram illustrating a configuration example of a communication path determination device according to a first example embodiment.

FIG. 2 is a flowchart illustrating an example of a flow of processing in the communication path determination method according to the first example embodiment.

FIG. 3 is a schematic diagram illustrating a configuration example of a communication network according to a second example embodiment.

FIG. 4 is a block diagram illustrating a configuration example of a communication path determination device according to the second example embodiment.

FIG. 5 is a flowchart illustrating an example of a flow of processing in a communication path determination method according to the second example embodiment.

FIG. 6 is a schematic diagram illustrating an example of a moving weather event.

FIG. 7 is a schematic diagram illustrating a configuration example of a communication system according to a third example embodiment.

FIG. 8 is a block diagram illustrating a hardware configuration of a computer as an implementation example of the communication path determination device according to each example embodiment of the present invention.

### EXAMPLE EMBODIMENT

### First Example Embodiment

A first example embodiment of the present invention will be described in detail with reference to the drawings. The present example embodiment is a basic form of the example embodiment described below.

### (Configuration of Communication Path Determination Device)

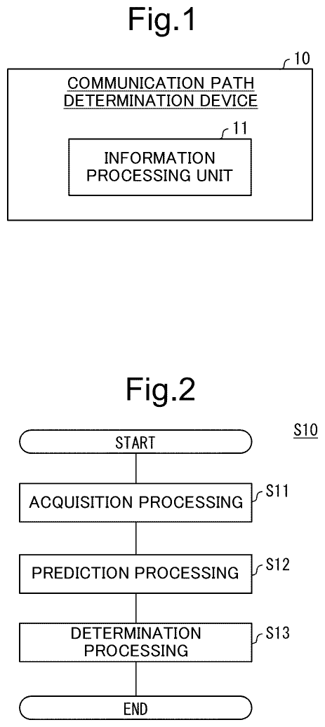

A configuration of a communication path determination device according to the present example embodiment will be described with reference to FIG. 1. FIG. 1 is a block diagram illustrating a configuration example of a communication path determination device 10 according to the first example embodiment. The communication path determination device 10 includes an information processing unit 11, and determines a communication path on a communication network including a plurality of nodes and a plurality of links connecting the plurality of nodes by free-space optical communication. The information processing unit 11 executes a communication path determination method S10.

FIG. 2 is a flowchart illustrating an example of a flow of processing in the communication path determination method S10 according to the first example embodiment. A block diagram illustrates a configuration example of a processing system controlled by the communication path determination device. The communication path determination method S10 includes acquisition processing (step S11) and prediction processing (step S12).

### (1) Acquisition Processing (Step S11)

The information processing unit 11 acquires weather information and communication quality of at least one link among a plurality of links.

### (2) Prediction Processing (Step S12)

The information processing unit 11 predicts the communication quality of the plurality of links after a predetermined time based on the weather information and the communication quality of at least one link. For example, the information processing unit 11 estimates that a weather event occurs at a specific position (as an example, a position of a link in which communication quality has deteriorated) based on weather information and communication quality of at least one link. Furthermore, the information processing unit 11 estimates the position of the weather event after a predetermined time based on the weather information and the communication quality of at least one link, and predicts the communication quality of a plurality of links after the predetermined time based on these.

### (3) Determination Processing (Step S13)

The information processing unit 11 determines a communication path after a predetermined time based on the predicted communication quality.

As described above, the communication path determination device 10 according to the present example embodiment determines a communication path on a communication network having a plurality of nodes and a plurality of links connecting the plurality of nodes by free-space optical communications, and is provided with the information processing unit 11. The information processing unit 11 executes: acquisition processing (step S11) for acquiring weather information and the communication quality of at least one link Ri among the plurality of links; prediction processing (step S12) for, on the basis of the weather information and the communication quality of the at least one link, predicting communication qualities of the plurality of links after a predetermined time; and determination processing (step S13) for, on the basis of the predicted communication qualities, determining a communication path after the predetermined time.

That is, the communication path determination device 10 estimates the position of the weather event after a predetermined time based on the weather information and the communication quality of at least one link, thereby predicting the communication quality of the plurality of links after the predetermined time, and determines the communication path after the predetermined time based on the predicted communication quality. Therefore, according to the communication path determination device 10 according to the present example embodiment, a future communication path can be determined in consideration of the influence of a local weather event.

The communication path determination method S10 according to the present example embodiment is a communication path determination method for determining a communication path on a communication network having a plurality of nodes and a plurality of links connecting the plurality of nodes by free-space optical communication. The method includes acquisition processing (S11) for acquiring weather information and the communication quality of at least one link among the plurality of links, prediction processing (S12) for, based on the weather information and the communication quality of the at least one link, predicting communication qualities of the plurality of links after a predetermined time, and determination processing (S13) for, based on the predicted communication qualities, determining a communication path after the predetermined time.

That is, the communication path determination method S10 estimates the position of the weather event after a predetermined time based on the weather information and the communication quality of at least one link, thereby predicting the communication quality of the plurality of links after the predetermined time, and determines the communication path after the predetermined time based on the predicted communication quality. Therefore, according to the communication path determination method S10 according to the present example embodiment, a future communication path can be determined in consideration of the influence of a local weather event.

### Second Example Embodiment

A second example embodiment of the present invention will be described in detail with reference to the drawings. Components having the same functions as the components described in the first example embodiment are denoted by the same reference signs, and the description thereof will be appropriately omitted.

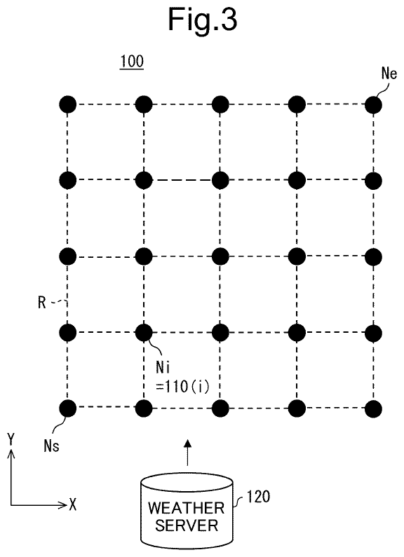

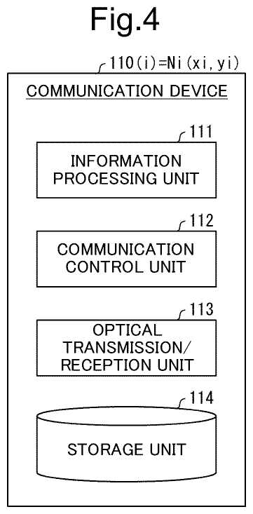

FIG. 3 is a schematic diagram illustrating a configuration example of a communication network 100 according to the second example embodiment. FIG. 4 is a block diagram illustrating a configuration example of a communication path determination device 110 according to the second example embodiment.

The communication network 100 includes a plurality of nodes N and a plurality of links R connecting the plurality of nodes N by free-space optical communication. The communication network 100 further includes a communication path determination device 110 and a weather information server 120.

In the free-space optical communication, communication is performed by transmitting and receiving light beams between the nodes N. As the light beam, for example, visible light or infrared rays can be used. The free-space optical communication has characteristics such as ease of installation, high confidentiality (eavesdropping difficulty due to a thin light beam), and a high communication speed.

Here, the free-space optical communication through the atmosphere is easily affected by the state of the atmosphere. A local weather event, for example, heavy rain or strong wind, may degrade the communication quality of the link R. For example, a local and short-time communication failure (communication interruption) may occur.

The communication path determination device 110 predicts communication quality on each link R after a predetermined time (in the future), and determines a communication path after the predetermined time. For example, when information is transmitted from the node Ns to the node Ne, the path from the node Ns to the node Ne can be appropriately selected by selecting the link R. Then, when local communication interruption occurs in the communication network 100, the communication path is determined so as to avoid the link R in which the communication is interrupted. As a result, it is possible to maintain an excellent communication state on the communication network 100.

The communication path determination device 110 can be disposed at each node N as a communication device. That is, the communication path determination device 110 functions as a communication device for arrangement at one node on the communication network 100 including a plurality of nodes N and a plurality of links R connecting the plurality of nodes by free-space optical communication. In the following description, it is assumed that the communication path determination device 110 is disposed at each node N.

The communication path determination device 110 includes an information processing unit 111, a communication control unit 112, an optical transmission/reception unit 113, and a storage unit 114.

The information processing unit 111 executes a communication path determination method S100 described later. The communication control unit 112 controls communication by the optical transmission/reception unit 113.

The optical transmission/reception unit 113 performs free-space optical communication between the node N where the communication path determination device 110 is disposed and the adjacent node N. The optical transmission/reception unit 113 functions as an optical transmission/reception unit for performing free-space optical communication with a communication device arranged in another node on the communication network 100.

At this time, the optical transmission/reception unit 113 can switch the node N to communicate with. Here, as illustrated in FIG. 3 for ease of understanding, two or more nodes in two directions (x direction, y direction) can be selected as communication partners. For example, in the node Ni, the communication path can be switched by selecting four nodes in the x direction and the y direction as communication partners.

The storage unit 114 stores position information of the node N.

The weather information server 120 is a server device that holds weather information and provides the weather information to the communication path determination device 110 via the communication network 100 or other communication means. The weather information is, for example, information on wind speed and rainfall in an area where the communication network 100 is arranged. Here, the information on the wind speed may be provided as a wind speed vector including the wind direction. The information on the wind speed and the rainfall may be information on an average wind speed and rainfall (average wind speed, average grain amount), but may include information on a wind speed and rainfall related to a strong wind and a heavy rain (as an example, localized strong winds, localized heavy rainfall) in a short time.

### (Communication Path Determination Method S100)

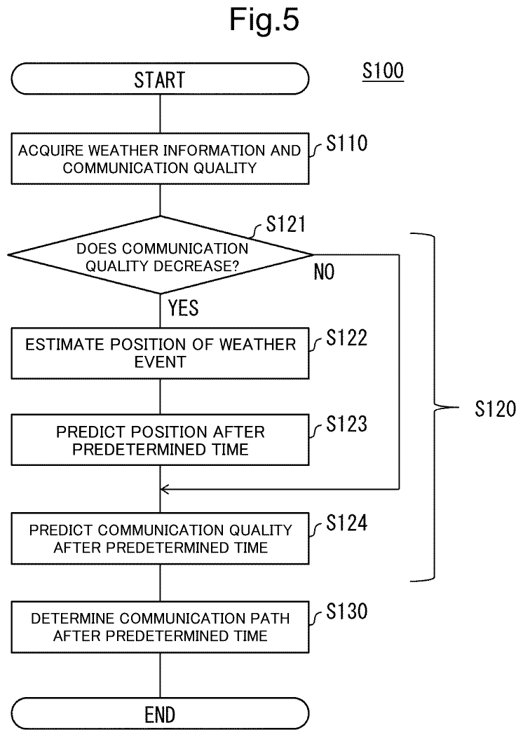

FIG. 5 is a flowchart illustrating an example of a flow of processing in the communication path determination method S100 according to the second example embodiment. Details of the communication path determination method S100 will be described below with reference to FIG. 5.

### (1) Acquisition Processing (Step S11)

The information processing unit 111 acquires weather information and communication quality of at least one link among the plurality of links R.

The information processing unit 111 can acquire weather information (for example, weather forecast information) from the weather information server 120. The weather information is, for example, information on an average wind speed (as an example, an average wind speed vector) and an average rainfall amount. The weather information may include information on an instantaneous maximum wind speed or an instantaneous maximum precipitation amount.

The information processing unit 111 can acquire the communication quality on the link R connected to the optical transmission/reception unit 113 (node Ni) of the own device. The information processing unit 11 can provide the communication quality of the link R acquired from the optical transmission/reception unit 113 of the own device to the other communication path determination device 110 via the communication network 100 or other communication means. On the other hand, the information processing unit 111 can acquire the communication quality on the link R connected to another node Nj from another communication path determination device 110.

The communication quality is, for example, the intensity of the light beam received from the link R, a bit error rate (BER), and a signal-to-noise ratio (SNR). Among them, the intensity of the light beam can be simply used as an index of communication quality. In free-space optical communication, the intensity of a light beam varies depending on the state of the atmosphere (for example, a strong wind or a heavy rain), and when the intensity of the light beam decreases to some extent or more, the bit error rate also rapidly deteriorates.

### (2) Prediction Processing (Step S12)

The information processing unit 111 predicts the communication quality of the plurality of links after a predetermined time based on the weather information and the communication quality of at least one link (step S12).

For example, in this prediction processing, the information processing unit 11 estimates the position of the weather event that reduces the communication quality of the link R based on the acquired communication quality (of the link R). This weather event may include localized heavy rainfall or localized strong winds. Localized heavy rainfall or localized strong winds are difficult to forecast, and estimation of a position based on communication quality of the link R is effective.

More specifically, in the prediction processing, the information processing unit 111 estimates the position of the weather event based on the position of the link whose acquired communication quality is equal to or less than a predetermined standard. That is, it can be considered that a local weather event occurs in the vicinity of the link R whose communication quality is equal to or less than a predetermined standard, and the communication quality of the link R is deteriorated.

In the prediction processing, the information processing unit 111 estimates the moving direction and the moving speed of the weather event, and predicts the communication quality on the plurality of links R after a predetermined time based on the estimated position, moving direction, and moving speed of the weather event. That is, it is estimated in which direction and at what speed the weather event moves from the estimated position, and the communication quality of the link R of the communication network 100 accompanying the movement of the weather event is estimated. As the weather event moves, the communication quality of the link R whose communication quality has deteriorated due to the weather event is improved, and the communication quality of the link R whose communication quality has been good is deteriorated.

The moving direction and the moving speed of the weather event can be estimated based on the average wind speed vector. That is, the weather information includes information of an average wind speed vector, and the information processing unit 111 can estimate the moving direction and the moving speed of the weather event based on the average wind speed vector.

A decrease in communication quality due to a weather event can be predicted by, for example, an instantaneous maximum wind speed or an instantaneous maximum precipitation amount. That is, the weather information may include information on the instantaneous maximum wind speed or the instantaneous maximum precipitation amount, and the information processing unit 111 may predict the communication quality on the plurality of links R after a predetermined time based on the position, the moving direction, and the moving speed of the estimated weather event, and the instantaneous maximum wind speed or the instantaneous maximum precipitation amount.

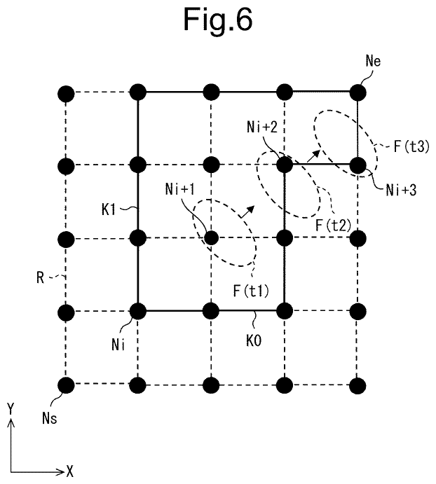

FIG. 6 is a schematic diagram illustrating an example of a moving weather event. The prediction of the communication quality in the case where the weather event is strong wind or heavy rain will be described below with reference to FIG. 6.

### (a) Degradation in Communication Quality Due to Strong Wind

Hereinafter, the calculation of the degradation in communication quality of the link R due to the strong wind will be described below. In the link R connected to the node Ni, when the degradation in communication quality due to strong wind is found, a risk of strong wind in another node N changes. Then, the communication quality in the link connected to the node having an increased risk of strong wind decreases.

It is assumed that the node Ni has a link whose communication quality is equal to or less than a predetermined standard. For example, it is assumed that communication is interrupted (for example, instantaneous interruption) in the link Rij of the node Ni. At this time, the estimated instantaneous wind speed Wi′ (vector) at the node Ni is expressed as follows.

$${Wi}^{′} = s ( Δ t ) \times ( x , y )$$

Δt: communication interruption time
s(Δt): function indicating the anti-wind pressure rigidity at the position of the node Ni
(x, y): wind speed vector

The function s(Δt) is expressed as follows, for example.

$$s ( Δ t ) = k i \times Δ {t}^{1 / 2}$$

ki: coefficient of anti-wind pressure rigidity at position of node Ni

The strong wind risk area r(t) is expressed as follows.

$$r ( t ) = vi + {Wi}^{′} \times t + mi$$

vi: position vector of node Ni
t: elapsed time from interruption start time to of communication
mi: assumed margin of strong wind wavefront at node Ni

The assumed margin mi can be expressed as follows.

$$mi = ( ( α \times γ ) / β ) \times ( 1 , - x / y )$$

$$- u < γ < u$$

α: parameter representing average wind speed
β: parameter representing ratio of instantaneous maximum wind speed to average wind speed
γ, u: adjustment parameter of strong wind wavefront

A strong wind risk qj(t) at any node Nj is expressed as follows.

$$qj ( t ) = δ / {( vj - r ( t ) )}^{2}$$

δ: adjustment parameter of risk intensity
vj: position vector of node Nj

The communication quality of the link R can be estimated based on the strong wind risk qj(t) calculated as described above.

### (b) Degradation in Communication Quality Due to Downpour

Hereinafter, the calculation of the degradation in communication quality of the link R due to the downpour will be described below. In the link R connected to the node Ni, when the degradation in communication quality due to downpour is found, a risk of downpour in another node N changes. Then, the communication quality in the link connected to the node having an increased risk of downpour decreases.

It is assumed that the node Ni has a link whose communication quality is equal to or less than a predetermined standard. For example, it is assumed that communication is interrupted (for example, instantaneous interruption) in the link Rij of the node Ni. At this time, the estimated instantaneous precipitation amount si′ at the node Ni is expressed as follows.

$${si}^{′} = max ( rth + φ \times Δ t , s )$$

rth: precipitation threshold (precipitation amount in which communication is assumed to be disabled due to the influence of rainfall)
φ: adjustment parameter
Δt: communication interruption time
s: precipitation amount (weather information, for example, the precipitation amount indicated in the weather forecast)

The precipitation threshold rth can be calculated by, for example, the following equation.

$$rth = rb \times u$$

rb: reference threshold of the precipitation amount, that is, the precipitation amount at which communication is interrupted at the reference communication distance (for example, 1 km) (for example, 100 mm/h)
u: communication distance (distance between nodes, that is, length of link)

The reference threshold rb of the precipitation amount can be determined by measurement in advance.

The downpour risk area r(t) is expressed as follows.

$$r ( t ) + vi + Wav \times t + mi$$

vj: position vector of node Ni
Wav: average wind speed vector
t: elapsed time from interruption start time to of communication
mi: assumed margin of downpour area

The assumed margin mi can be expressed as follows.

$$mi = ( ( γ \times s ) / {s}^{′} ) \times ( 1 , - x / y )$$

$$- u < γ < u$$

s′: estimated precipitation amount (precipitation amount estimated from communication interruption time Δt)
γ, u: adjustment parameter of downpour area

The estimated precipitation amount s′ is set not to be smaller than the precipitation amount s (s′≥s).

The downpour risk qj(t) at any node Nj is expressed as follows.

$$qj ( t ) = δ / {( vj - r ( t ) )}^{2}$$

δ: adjustment parameter of risk intensity
vj: position vector of node Ni

The communication quality of the link R can be estimated based on the downpour risk qj(t) calculated as described above.

### (3) Determination Processing (Step S13)

The information processing unit 11 determines a communication path after a predetermined time based on the predicted communication quality.

For example, in the determination processing, the information processing unit 111 can determine the communication path by excluding a link whose predicted communication quality is lower than a predetermined standard from the plurality of links R. As illustrated in FIG. 6, as the time t passes from t1 to t3, the weather event F(t) moves from F(t1) to F(t3). The information processing unit 111 can select the communication path K1 instead of the communication path K0 in order to avoid the link R whose communication quality is predicted to deteriorate as the weather event F(t) approaches.

Here, for ease of understanding, it is assumed that the communication path determination device 110(i) is arranged at the node Ni, receives information from the node Ns, and transfers the information to the node Ne. However, the communication path determination device 110(i) may be disposed at any node of the communication network 100.

On the other hand, in the determination processing, the information processing unit 111 may set a plurality of communication costs C relevant to each of the plurality of links R based on the predicted communication quality, and determine the communication path based on the plurality of communication costs C.

Hereinafter, an example of a method of determining a communication path based on the communication cost C of the link R will be described.

The communication cost C(k, t) in the link Rk can be defined as follows, for example.

$$C ( k , t ) = C ( h , g , t ) = Co ( h , g ) + qh ( t ) + qg ( t )$$

Co(h, g): communication cost between nodes Nh and Ng at the start point and the end point of the link Rk
k: identifier of link Rk
t: time
qh: risk at node Nh (strong wind risk, downpour risk, or sum of strong wind risk and downpour risk)
qg: risk at node Ng (strong wind risk, downpour risk, or sum of strong wind risk and downpour risk)

The communication cost Co(h, g) is determined based on the communication distance L(h, g) and the congestion situation D, and is expressed by, for example, the following expression.

$$Co ( h , g ) = μ \times L ( h , g ) \times D = μ + \vert vh - vg \vert \times D$$

μ: adjustment parameter
L(h, g): communication distance between nodes Nh and Ng
D: congestion situation of link Rk, for example, the measured or estimated link utilization rate
vh: position vector of node Nh
vg: position vector of node Ng

The communication cost C(K, t) of the communication path K is expressed as a sum of the communication costs C(k, t) of the link R included in the communication path K.

$$C ( K , t ) = ΣC ( k , t )$$

The information processing unit 111 selects the communication path K with the lowest communication cost C(K, t). For this selection, for example, a known algorithm such as Dijkstra's algorithm can be used.

As described above, the communication path determination device 110 predicts the communication quality of the plurality of links after the predetermined time based on the weather information and the communication quality of at least one link, and determines the communication path after the predetermined time based on the predicted communication quality. Therefore, according to the communication path determination device 110 according to the present example embodiment, a future communication path can be determined in consideration of the influence of a local weather event.

### Third Example Embodiment

A third example embodiment of the present invention will be described in detail with reference to the drawings. Components having the same functions as the components described in the first example embodiment are denoted by the same reference signs, and the description thereof will be appropriately omitted.

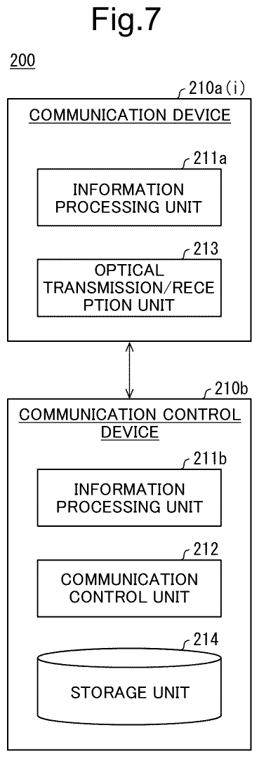

FIG. 7 is a schematic diagram illustrating a configuration example of a communication system 200 according to the third example embodiment. The communication system 200 includes a communication device 210a(i) and a communication control device 210b. The communication device 210a(i) is a communication device to be arranged at one node Ni on a communication network including a plurality of nodes Ni and a plurality of links R connecting the plurality of nodes Ni by free-space optical communication.

The communication device 210a(i) includes an information processing unit 211a and an optical transmission/reception unit 213. The optical transmission/reception unit 213 is an optical transmission/reception unit for performing free-space optical communication with a communication device disposed at another node Ni on the communication network.

The information processing unit 211a executes acquisition processing for acquiring weather information and communication quality of at least one link among a plurality of links, prediction processing for predicting the communication quality of the plurality of links after a predetermined time based on the weather information and the communication quality of the at least one link, and notification processing for notifying the predicted communication quality.

The information processing unit 211a acquires the communication quality of the link R to which its own device (the communication device 210a(i)) is connected, and notifies the other device (the other communication device 210a(j)) of the communication quality.

The communication control device 210b includes an information processing unit 211a, a communication control unit 212, and a storage unit 214. The information processing unit 211a executes determination processing for determining a communication path after a predetermined time based on the predicted communication quality notified from the communication device 210a(i). The communication control unit 212 controls communication by the communication device 210a(i) based on the determined communication path. The storage unit 214 stores position information of the node N.

The communication control device 210b may be arranged in each node N, or may be arranged in a communication network independently of the node N. For example, one communication control device 210b may be arranged in the communication network to control communication in the communication device 210a(i) arranged in each node N.

Here, the communication device 210a(i) predicts communication quality over a plurality of links after a predetermined time, and notifies the communication control device 210b of the predicted communication quality. On the other hand, the communication device 210a(i) may notify the communication control device 210b of the communication quality of the link R to which its own device (the communication device 210a(i)) is connected, and the communication control device 210b may predict the communication quality of a plurality of links after a predetermined time based on the weather information and the communication quality of the link notified from the communication device 210a(i).

### [Example of Implementation by Software]

Some or all of the functions of the information processing unit 111 may be achieved by hardware such as an integrated circuit (IC chip) or may be achieved by software.

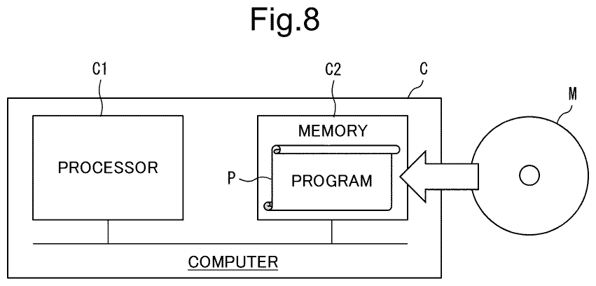

In the latter case, the information processing unit 111 is implemented, for example, by a computer that executes a command of a program that is software for achieving each function. An example of such a computer (hereinafter, referred to as a computer C) is illustrated in FIG. 8. The computer C includes at least one processor C1 and at least one memory C2. A program P for causing the computer C to operate as the information processing unit 111 is recorded in the memory C2. In the computer C, the processor C1 executes each function of the information processing unit 111 by reading the program P from the memory C2 and executing the program P.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Information 1]

The present invention is not limited to the above-described example embodiments, and various alterations can be made within the scope described in the claims. For example, example embodiments obtained by appropriately combining the technical means disclosed in the above-described example embodiments are also included in the technical scope of the present invention.

### [Supplementary Information 2]

Some or all the above-described example embodiments may be described as the follows. However, the present invention is not limited to the following aspects.

### (Supplementary Note 1)

A communication path determination device that determines a communication path on a communication network having a plurality of nodes and a plurality of links connecting the plurality of nodes by free-space optical communications, the device including an information processing unit, in which the information processing unit executes: acquisition processing for acquiring weather information and communication quality of at least one link among the plurality of links; prediction processing for, based on the weather information and the communication quality of the at least one link, predicting communication qualities of the plurality of links after a predetermined time; and determination processing for, based on the predicted communication qualities, determining a communication path after the predetermined time.

### (Supplementary Note 2)

The communication path determination device according to Supplementary Note 1, in which, in the determination processing, the information processing unit determines the communication path by excluding a link having the predicted communication quality lower than a predetermined standard from the plurality of links.

### (Supplementary Note 3)

The communication path determination device according to Supplementary Note 1, in which, in the determination processing, the information processing unit sets a plurality of communication costs relevant to each of the plurality of links based on the predicted communication quality, and determines the communication path based on the plurality of communication costs.

### (Supplementary Note 4)

The communication path determination device according to any one of Supplementary Notes 1 to 3, in which, in the prediction processing, the information processing unit estimates a position of a weather event that degrades communication quality of a link based on the acquired communication quality.

### (Supplementary Note 5)

The communication path determination device according to Supplementary Note 4, in which the weather event is localized heavy rainfall or localized strong winds.

### (Supplementary Note 6)

The communication path determination device according to Supplementary Note 4, in which,
in the prediction processing, the information processing unit
estimates a position of the weather event based on a position of a link having the acquired communication quality equal to or less than a predetermined standard.

### (Supplementary Note 7)

The communication path determination device according to Supplementary Note 4, in which in the prediction processing, the information processing unit is configured to estimate a moving direction and a moving speed of the weather event, and predict communication quality in the plurality of links after the predetermined time based on the estimated position, moving direction, and moving speed of the weather event.

### (Supplementary Note 8)

The communication path determination device according to Supplementary Note 7, in which
the weather information includes information of an average wind speed vector, and
the information processing unit estimates a moving direction and a moving speed of the weather event based on the average wind speed vector.

### (Supplementary Note 9)

The communication path determination device according to Supplementary Note 7, in which the weather information includes information of an instantaneous maximum wind speed or an instantaneous maximum precipitation amount, and the information processing unit predicts communication quality in the plurality of links after the predetermined time based on a position, a moving direction, and a moving speed of the estimated weather event, and the instantaneous maximum wind speed or the instantaneous maximum precipitation amount.

### (Supplementary Note 10)

A communication path determination method for determining a communication path on a communication network having a plurality of nodes and a plurality of links connecting the plurality of nodes by free-space optical communications, the method including:
acquisition processing for acquiring weather information and communication quality of at least one link among the plurality of links; prediction processing for, based on the weather information and the communication quality of the at least one link, predicting communication qualities of the plurality of links after a predetermined time; and determination processing for, based on the predicted communication qualities, determining a communication path after the predetermined time.

### (Supplementary Note 11)

A communication device for arrangement at one node on a communication network having a plurality of nodes and a plurality of links connecting the plurality of nodes by free-space optical communication, the communication device including: an optical transmission/reception unit that performs free-space optical communication with a communication device arranged at another node on the communication network; and an information processing unit, in which the information processing unit executes: acquisition processing for acquiring weather information and communication quality of at least one link among the plurality of links; prediction processing for predicting the communication quality of the plurality of links after a predetermined time based on the weather information and the communication quality of the at least one link; and determination processing for determining a communication path after the predetermined time based on the predicted communication quality.

### (Supplementary Note 12)

A communication device for arrangement at one node on a communication network having a plurality of nodes and a plurality of links connecting the plurality of nodes by free-space optical communication, the communication device including: an optical transmission/reception unit that performs free-space optical communication with a communication device arranged at another node on the communication network; and an information processing unit, in which the information processing unit executes: acquisition processing for acquiring weather information and communication quality of at least one link among the plurality of links; prediction processing for predicting the communication quality of the plurality of links after a predetermined time based on the weather information and the communication quality of the at least one link; and notification processing for notifying the predicted communication quality.

### (Supplementary Note 13)

The communication device according to Supplementary Note 12, in which the information processing unit acquires communication quality of a link to which the own device is connected and notifies another device of the communication quality.

### (Supplementary Note 14)

A communication control device including a second information processing unit that executes determination processing for determining a communication path after the predetermined time based on the predicted communication quality notified from the communication device according to Supplementary Note 12.

### (Supplementary Note 15)

A communication system including a communication device according to Supplementary Note 12 and a communication control device according to Supplementary Note 14.

### (Supplementary Note 16)

A communication path determination device that determines a communication path on a communication network having a plurality of nodes and a plurality of links connecting the plurality of nodes by free-space optical communications, the device including at least one processor, in which the processor executes: acquisition processing for acquiring weather information and communication quality of at least one link among the plurality of links; prediction processing for, based on the weather information and the communication quality of the at least one link, predicting communication qualities of the plurality of links after a predetermined time; and determination processing for, based on the predicted communication qualities, determining a communication path after the predetermined time.

This communication path determination device may further include a memory, and the memory may store a program for causing the processor to execute the acquisition processing, the prediction processing, and the determination processing. This program may be recorded in a computer-readable non-transitory tangible recording medium.

### REFERENCE SIGNS LIST

100 communication network
110 communication path determination device
111 information processing unit
112 communication control unit
113 optical transmission/reception unit
114 storage unit
120 weather information server

What is claimed is:

1. A communication path determination device that determines a communication path on a communication network having a plurality of nodes and a plurality of links connecting the plurality of nodes by free-space optical communications, the device comprising an information processor,
wherein the information processor executes:
acquisition processing for acquiring weather information and communication quality of at least one link among the plurality of links;
prediction processing for, based on the weather information and the communication quality of the at least one link, predicting communication qualities of the plurality of links after a predetermined time; and
determination processing for, based on the predicted communication qualities, determining a communication path after the predetermined time.

2. The communication path determination device according to claim 1, wherein,
in the determination processing, the information processor
determines the communication path by excluding a link having the predicted communication quality lower than a predetermined standard from the plurality of links.

3. The communication path determination device according to claim 1, wherein,
in the determination processing, the information processor
sets a plurality of communication costs relevant to each of the plurality of links based on the predicted communication quality, and determines the communication path based on the plurality of communication costs.

4. The communication path determination device according to claim 1, wherein,
in the prediction processing, the information processor
estimates a position of a weather event that degrades communication quality of a link based on the acquired communication quality.

5. The communication path determination device according to claim 4, wherein the weather event is localized heavy rainfall or localized strong winds.

6. The communication path determination device according to claim 4, wherein,
in the prediction processing, the information processor
estimates a position of the weather event based on a position of a link having the acquired communication quality equal to or less than a predetermined standard.

7. The communication path determination device according to claim 4, wherein
in the prediction processing, the information processor is configured to
estimate a moving direction and a moving speed of the weather event, and
predict communication quality in the plurality of links after the predetermined time based on the estimated position, moving direction, and moving speed of the weather event.

8. The communication path determination device according to claim 7, wherein
the weather information includes information of an average wind speed vector, and
the information processor estimates a moving direction and a moving speed of the weather event based on the average wind speed vector.

9. The communication path determination device according to claim 7, wherein
the weather information includes information of an instantaneous maximum wind speed or an instantaneous maximum precipitation amount, and
the information processor predicts communication quality in the plurality of links after the predetermined time based on a position, a moving direction, and a moving speed of the estimated weather event, and the instantaneous maximum wind speed or the instantaneous maximum precipitation amount.

10. A communication path determination method for determining a communication path on a communication network having a plurality of nodes and a plurality of links connecting the plurality of nodes by free-space optical communications, the method comprising:
acquisition processing for acquiring weather information and communication quality of at least one link among the plurality of links;
prediction processing for, based on the weather information and the communication quality of the at least one link, predicting communication qualities of the plurality of links after a predetermined time; and
determination processing for, based on the predicted communication qualities, determining a communication path after the predetermined time.

11. A communication device for arrangement at one node on a communication network having a plurality of nodes and a plurality of links connecting the plurality of nodes by free-space optical communication, the communication device comprising:
an optical transmission/reception circuit that performs free-space optical communication with a communication device arranged at another node on the communication network; and
an information processor, wherein
the information processor executes:
acquisition processing for acquiring weather information and communication quality of at least one link among the plurality of links;
prediction processing for predicting the communication quality of the plurality of links after a predetermined time based on the weather information and the communication quality of the at least one link; and
determination processing for determining a communication path after the predetermined time based on the predicted communication quality.

12-15. (canceled)
